(19) United States
(12) Patent Application Publication
(10) Pub. No.: US 2012/0011735 A1
(43) Pub. Date: Jan. 19, 2012

(54) DRYER

(76) Inventors: Sang Wook Hong, Seoul (KR); Ji Hee Kim, Seoul (KR); Sang Su Lee, Seoul (KR); Sun Young Park, Seoul (KR); Bon Kwon Koo, Seoul (KR); Jae Won Chang, Seoul (KR); Ki Young Kang, Seoul (KR); Chang Kwon Park, Seoul (KR)

(21) Appl. No.: 13/259,932

(22) PCT Filed: Sep. 11, 2009
(86) PCT No.: PCT/KR2009/005187

§ 371 Date: Sep. 23, 2011

(30) Foreign Application Priority Data
May 4, 2009 (KR) 10-2009-0039047

(51) Int. Cl. F26B 11/02

(52) U.S. Cl. 34/108

(57) ABSTRACT

The present invention relates to a dryer (100), including a cabinet (110) which forms an exterior of the dryer (100), a drum (120, 120a, 120b, 120c) rotatably mounted in the cabinet (110), the drum (120, 120a, 120b, 120c) having a plurality of lifters (127, 127a, 127b, 127c), and a partition unit (200, 200a, 200b, 200c) slidably movable along the lifters (127, 127a, 127b, 127c) in a direction of a rotation axis of the drum (120, 120a, 120b, 120c) for partitioning a drying space of the drum (120, 120a, 120b, 120c), thereby permitting to use a space in the drum (120, 120a, 120b, 120c) of the dryer (100) effectively according to an amount of clothes.

### TECHNICAL FIELD

The present invention relates to dryers, and more specifically, the present invention relates to a dryer which can adjust a space in a drum of the dryer according to an amount of clothes.

### BACKGROUND ART

In general, in the dryers, such as drying and washing machines and dryers, there are exhaust type dryers and condensing type dryers depending on methods of treating humid air formed as drying objects are dried by hot air produced with a heater and introduced to the drum.

The exhaust type dryer discharges the humid air from the drum to an outside of the dryer, and the condensing type dryer condenses the humid air from the drum to remove moisture from the humid air and re-circulates dried air having the moisture removed therefrom to the drum again.

In a related art dryer, the drum rotates to make drying objects in the drum move up/down in the drum to dry the drying objects. In this instance, in order to dry the drying objects more effectively, hot air is supplied to the drum. In general, the hot air supplied to the drum moves from a rear upper side of the drum to a front lower side of the drum in drying the drying object and discharged to an outside of the drum.

In the meantime, the drum has a plurality lifters mounted therein. The lifters makes the drying objects to move up/down following rotation of the drum at the time of drying the drying objects for increasing drying efficiency of the drying objects.

### DISCLOSURE OF INVENTION

### Technical Problem

The related art drum has been designed such that an entire inside space of the drum can not, but be used regardless of an amount of clothes to be dried.

In the meantime, when a small amount of drying objects are dried, the drying objects rotate together with the drum in a state the drying objects stick to an inside circumference of the drum owing to rotation force of the drum and entangling of the drying objects at the lifters.

If the drying objects rotate together with the drum, since the drying objects rotate irrespective of the hot air which forms a path from the rear upper side to the front lower side of the drum, the drying efficiency of the drying objects becomes poor.

Moreover, when a plurality of drying objects are dried, of which drying rates are different, a drying object which can be dried easily can be damaged by excessive hot air, and, opposite to this, a drying object which can not be dried easily can fail complete drying.

Furthermore, a conventional drum of metal can cause noise due to buttons on clothes at the time of drying.

Since above problems can impair user satisfaction on the products, countermeasures have been required as early as possible.

### Solution to Problem

To solve the problems, an object of the present invention is to provide a dryer in which an inside space of a drum of the dryer can be used partitioned according to an amount of clothes.

Another object of the present invention is to provide a dryer in which movement of drying objects in the drum is limited to a path through which hot air passes for improving drying efficiency when a small amount of drying objects are dried.

Another object of the present invention is to provide a dryer which can prevent drying objects from being held at lifters when a small amount of drying objects are dried.

Further object of the present invention is to provide a dryer which can make drying positions of drying objects different when a plurality of drying objects having different drying rates are dried for improving drying efficiency and preventing the drying objects suffering from damage and incomplete drying.

To achieve these objects and other advantages and in accordance with the purpose of the invention, as embodied and broadly described herein, a dryer includes a cabinet which forms an exterior of the dryer, a drum rotatably mounted in the cabinet, the drum having a plurality of lifters, and a partition unit slidably movable along the lifters in a direction of a rotation axis of the drum for partitioning a drying space of the drum.

Preferably, the partition unit is of a bellows type which is extendable/contractible in the direction of the rotation axis of the drum.

Preferably, the partition unit partitions a drying space of the drum into a center space and an outer circumferential space.

Preferably, the lifter includes a slide groove formed in a length direction of the lifter, and the partition unitis formed to extend/contract along the slide groove.

Preferably, the partition unit includes a drying net of an elastic mesh material which is to form a cylinder, and a plurality of hooks at an outside circumference of the drying net for placing in the slide grooves for supporting the drying net.

Preferably, the drying net includes an elastic fastening band at an outside circumference of the drying net for fastening the hook thereto, and the hook has one end with a holding ring for holding the fastening band and the other end with a securing end for placing in and fastening to the slide groove.

Preferably, the partition unit includes a drying net of a elastic mesh material which is to form a cylinder, and a plurality of guide frames secured to an outside circumference of the drying net to maintain a sectional shape of the drying net and to be placed in the slide grooves.

Preferably, the guide frame includes a plurality of sides each connecting the plurality of lifters.

Preferably, the side includes an arc shape having a rotation axis the same with the drum.

Preferably, the guide frame includes a securing end to be placed in the slide groove at a corner of each of the sides.

Preferably, the dryer further includes moving unit for moving the guide frame along the slide groove.

Preferably, the moving unit is a movable frame of a shape memory metal arranged in zigzag along the lifter connected to the guide frame.

### Advantageous Effects of Invention

The dryer of the present invention has following advantageous effects.

The capability of partition of the inside space of the drum according to an amount of clothes permits to enhance efficiency of utilization of the space of the drum.

The limitation of movement of a small amount of drying objects within a path through which the hot air passes permits to improve drying efficiency.

The entangling of the drying objects at the lifters can be prevented at the time a small amount of drying objects are dried.

At the time of drying a plurality of drying objects having drying rates different from one another, drying efficiency can be improved and damage to and imperfect drying of the drying objects can be prevented by making drying positions of the drying objects different from one another.

The prevention of direct contact of the buttons or the like on the clothes to a surface of the drum permits to reduce noise from the drum.

### BRIEF DESCRIPTION OF DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 illustrates an exploded perspective view of a clothe dryer in accordance with a preferred embodiment of the present invention;

FIG. 2 illustrates a structure of a clothe dryer in accordance with a preferred embodiment of the present invention, schematically;

FIG. 3 illustrates a partial section of a drum and a partition unit in accordance with a preferred embodiment of the present invention;

FIG. 4 illustrates a front view of a drum and a partition unit in accordance with a preferred embodiment of the present invention;

FIG. 5 illustrates a partial section of a drum and a partition unit in accordance with another preferred embodiment of the present invention;

FIG. 6 illustrates a front view of a drum and a partition unit in accordance with another preferred embodiment of the present invention;

FIG. 7 illustrates a front view of a drum and a partition unit in accordance with another preferred embodiment of the present invention; and

FIG. 8 illustrates a partial section of a drum and a partition unit in accordance with another preferred embodiment of the present invention.

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts.

Names and symbols of parts defined in describing embodiments of the present invention are defined taking functions of the embodiment into account, and required not to understand that the names and symbols of parts do not limit elements of the embodiments, technically.

In order to describe the dryer of the present invention, for convenience's sake, a front loading condensing type dryer will be described taking as an example. However, the present invention is not limited to this, but the present invention is applicable to exhaust type dryers, or front loading type dryer and washing machines.

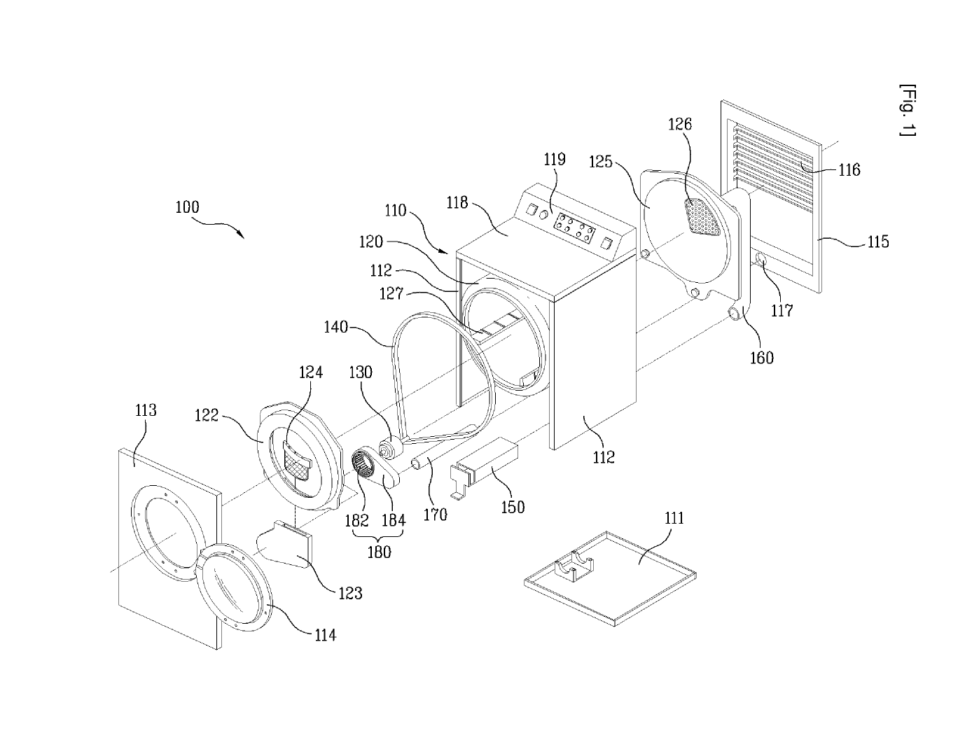

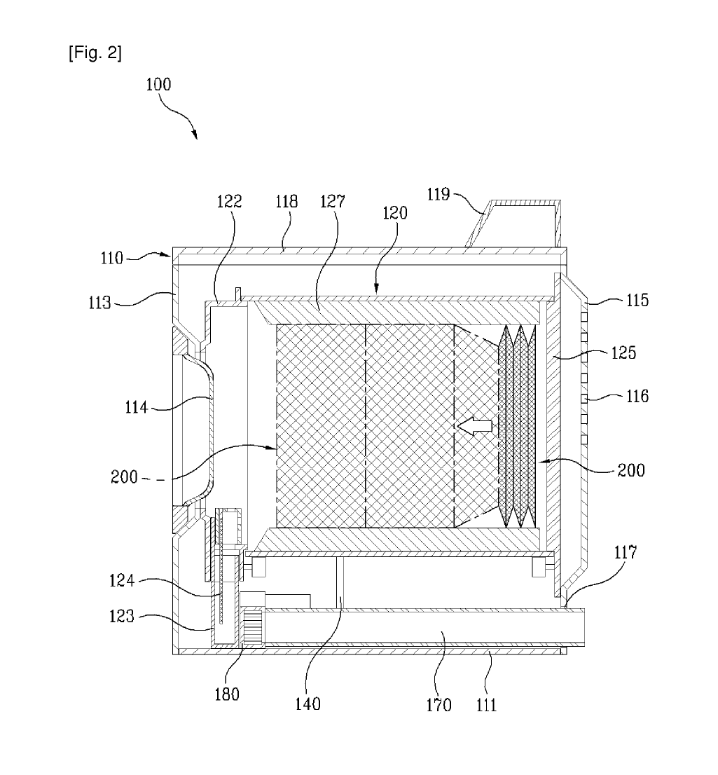

A dryer in accordance with a preferred embodiment of the present invention will be described with reference to FIGS. 1 and 2 attached hereto.

Referring to FIGS. 1 and 2, the dryer 100 includes a rotatable drum 120, and a motor 130 and a belt 140 for driving the drum 120 mounted in a cabinet 110 which forms an exterior of the dryer 100. Mounted in the cabinet 110, there are a heater 150 for heating air to produce hot air, and a hot air supply duct 160 for supplying the hot air from the heater 150 to the drum 120. Mounted also in the cabinet 110, there are a discharge duct 170 for discharging humid air heat exchanged with drying objects, and a blow unit 180 for drawing in the humid air, and so on.

For convenience's sake, though the embodiment shows and describes an indirect drive type in which the drum 120 is rotated by using the motor 130 and the belt 140, the present invention is not limited to this. That is, the present invention is applicable to a direct drive type in which the motor is connected to a rear of the drum 120 for rotating the drum 120 directly.

Elements of the dryer 100 will be described in detail.

The cabinet 110, forming an exterior of the dryer 100, includes a base 111 which forms a bottom thereof, one pair of side covers 112 mounted on the base 111 vertically, a front cover 113 and a rear cover 115 mounted to a front and a rear of the side covers 112 respectively, and a top cover 118 on a top of the side covers 112. In general, a control panel 119 having various operation switches mounted thereon is positioned at the top cover 118 or the front cover 113. The door 114 is mounted to the front cover 113. The rear cover 115 has an air inlet 116 for drawing external air, and an air outlet 117 for discharging air from the drum 120.

The drum 120 forms a drying space during the drying is in progress. In front/rear of the drum 120, there are a front supporter 122 and a rear supporter 125 for rotatably supporting the drum 120. Mounted between the front supporter 122 and the drum 120 and between the rear supporter and the drum 120, there are sealing members (not shown) for preventing leakage, respectively. That is, the front supporter 122 and the rear supporter 125 respectively close a front and a rear of the drum 120 to form a drying space and serve to support a front end and a rear end of the drum 120, respectively.

The front supporter 122 has an opening for communication with an outside of the dryer 100, which is closed/opened by the door 114, selectively. The front supporter 122 also has a lint duct 123 which is a passage of the air from the drum 120 to an outside of the drum 120 connected thereto. The lint duct 123 has a lint filter 124 mounted thereto. The lint duct 123 has one side of a blower unit 189 connected thereto and the other side of the blower unit 180 is connected to the discharge duct 170, and the discharge duct 170 is in communication with the air outlet hole 117 in the rear cover 115.

Therefore, upon putting the blower unit 180 into operation, air is discharged from the drum 120 to an outside of the drum 120 through the lint duct 123, the discharge duct 170, and the air outlet hole 117. In this instance, foreign matters, such as lint and the like, filtered at the lint filter 124. In general, the blower unit 180 has a blower 182 and a blower housing 184, and in general, the blower 182 is connected to the motor 130 for driving the blower 182.

In general, the rear supporter 125 has an opening 126 with a plurality of pass through holes, and the opening 126 has a hot air supply duct 160 connected thereto. The hot air supply duct 160 in communication with the drum 120 serves as a passage for supplying hot air to the drum 120. Accordingly, a heater 150 is mounted to the hot air supply duct 160.

In the meantime, mounted to an inside circumference of the drum 120, there are lifters 127 for liftering and dropping drying objects to upside down the drying objects for enhancing drying efficiency. The lifters 127 are mounted in various numbers and shapes depending on sizes and functions of the drum 120.

Provided on an inner side of the lifters 127 of the drum 120, there is a partition unit 200 for reducing a drying space of the drum 120. The partition unit 200 is detachably and slidably mounted to the lifters 127 mounted to the inside circumference of the drum 120. The partition unit 200, extendably/contractibly provided on the inner side of the lifters 127, partitions the drying space of the drum 120 into a center space and an outer space. The center space formed by the partition unit 200 limits a moving space of the drying objects following rotation of the drum 120 when a small amount of the drying objects are dried.

A partition unit 200a mounted in a drum 120a of the dryer 100 of the present invention will be described in detail with reference to the attached drawings. It is required that parts and reference symbols described hereafter are understood with reference to the foregoing description and drawings.

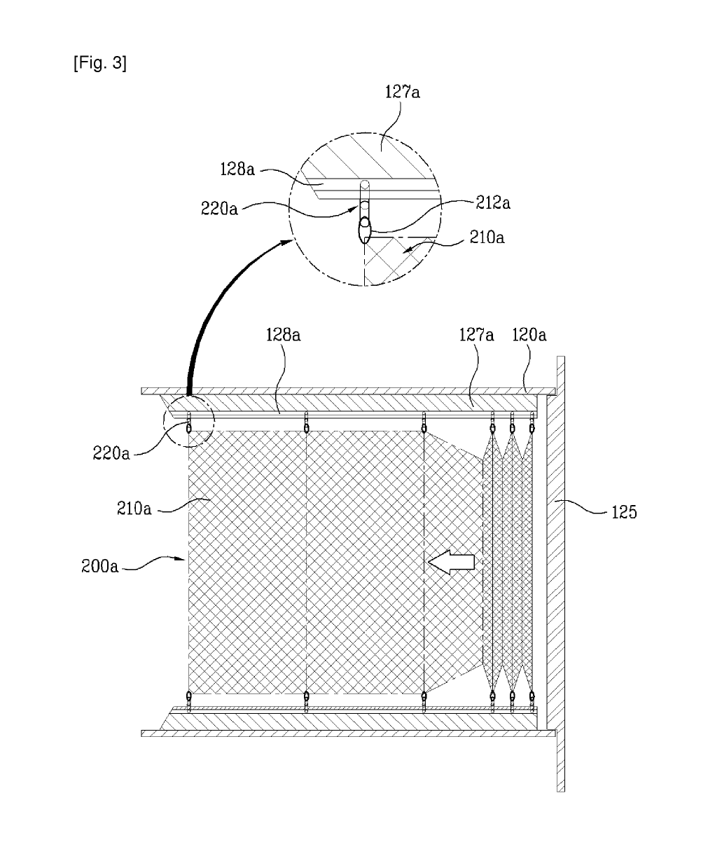

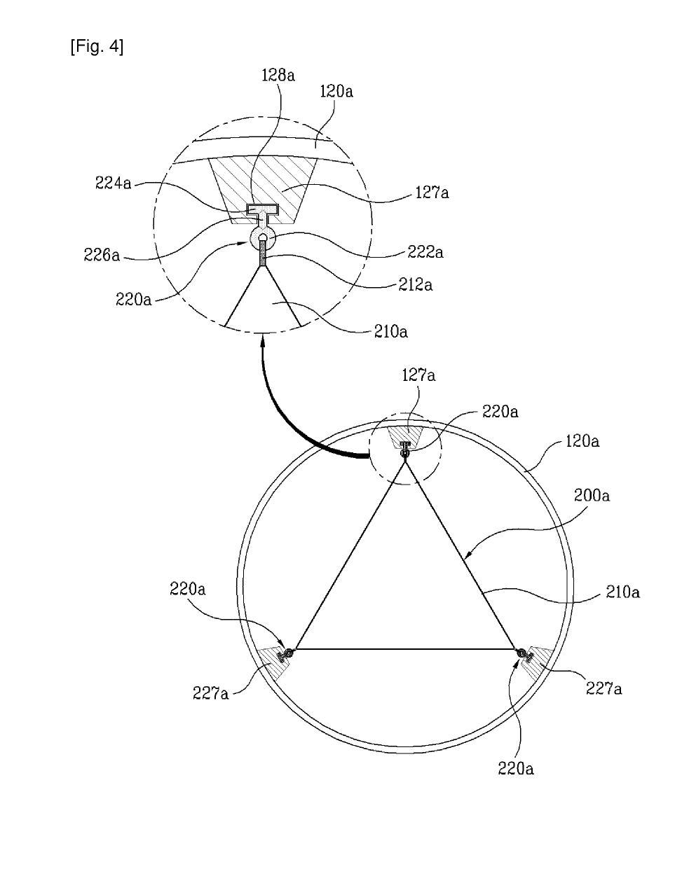

The drum 120a and the partition unit 200a in accordance with a preferred embodiment of the present invention will be described with reference to FIGS. 3 and 4.

As shown, the drum 120a has a plurality of lifters 127a fixedly secured to an inside surface of the drum 120a. The partition unit 200a is detachably and slidably mounted to edges of lifters 127a.

A number of the lifters 127a attached to an inside of the drum 120a may vary with sizes of the drum 120a. For convenience's sake, the embodiment will be described with reference a dryer having three lifters. However, this does not limit a number of the lifters 127a.

Each of the lifters 127a has a T shaped slide groove 128a extended in a length direction of the lifter 127a at an edge of the lifter 127a on a rotation axis side of the drum 120a. The slide groove 128a passes through a front of the lifter 127a. Though not shown, the slide groove 128a has one pair of fastening holes at opposite ends for fastening front/rear hooks 220a which will be described later thereto, respectively.

The partition unit 200a includes an elastic drying net 210a of a mesh material, and hooks 220a fastened to an outside of the drying net 210a and placed in the slide groove 128a in the lifter 127a.

It is preferable that the drying net 210a of an elastic material is formed to maintain a stretched state with a tension toward the rotation axis of the drum 120a when the partition unit 200a is mounted to the drum 120a.

It is also preferable that the drying net 210a is of a bellows type which can be extended in a length direction of the drum 120a such that the drying net 210a has a maximum length and space when the drying net 210a is extended, and has a minimum length and space when the drying net 210a is contracted.

The drying net 210a has fastening bands 212a at an outermost circumference with a number and positions in conformity with a number and positions of the lifters 127a mounted to the inside circumference of the drum 120a. A plurality of the fastening bands 212a of an elastic material are provided along a length of the lifter 127a and the drying net 210a. Each of the fastening bands 212a has the hook 220a secured thereto.

The hook 220a has a holding ring 222a for holding the fastening band 212a at one end, a securing end 224a at the other end for placing in the slide groove 128a for securing the hook 220a, and a body 226a connected between the holding ring 222a and the securing end 224a for moving along the slide groove 128a. The hook 220a is secured to the drying net 210a as the fastening band 212a at the drying net 210a is placed in the holding ring 222a.

According to the drum 120a and the partition unit 200a in accordance with a preferred embodiment of the present invention, when it is intended to dry a small amount of drying objects, by placing the hooks 220a secured to the drying net of the partition unit 200a into the lifters 127a of the drum 120a, the partition unit 200a is mounted.

In more detail, the securing ends 224a of the hooks 220a are placed in the slides grooves 128a matched to the securing ends 224a passed through toward the front side of the lefts 127a of the drum 120a, respectively. Then, if the hooks 220a are respectively moved along the slide grooves 128a of the lifters 127a to extend the drying net 210a of the partition unit 200a to form the drying space. In this instance, the hooks 220a at the front and the rear of the drying net 210a are placed in and fastened to the fastening holes (not shown) in the slide groove of the lifters 127a, respectively.

According to this, the inside of the drum 120a is partitioned into an inside and an outside of the partition unit 200, enabling the small amount of drying objects to be placed in an inside space of the drying net 210a of the partition unit 200a or in a space formed between the drum 120a and the drying net 210a for drying.

In the meantime, even though the embodiment describes the dryer of the present invention having three lifters 127a in the drum 120a as an example, such that the partition unit 200a forms a space having a triangular section owing to the three lifters 127a, the sectional shape of the partition unit 200a can vary with a number of the lifters 127a.

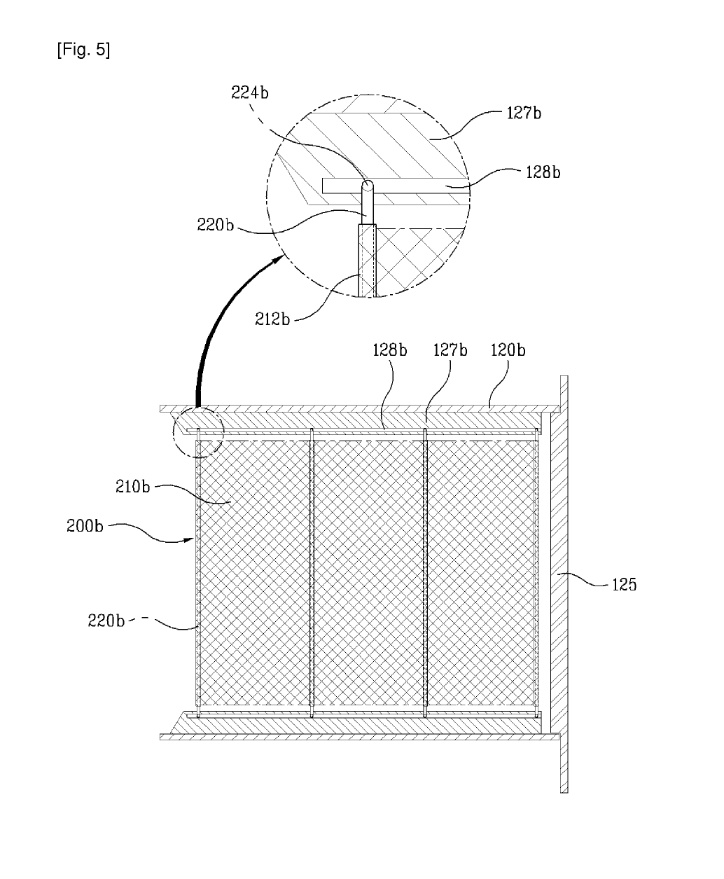

A drum and a partition unit in accordance with another preferred embodiment of the present invention will be described with reference to FIGS. 5 to 7.

As shown, the drum 120b has a plurality of lifters 127b fixedly secured to an inside circumference of the drum 120b. The partition unit 200b is detachably and slidably mounted to edges of the lifters 127b.

Each of the lifters 127b has a T shaped slide groove 128b extended in a length direction of the lifter 127b at an edge of the lifter 127b on a rotation axis side of the drum 120b. Though not shown, the slide groove 128b has one pair of fastening holes at opposite ends for fastening front/rear guide frames 220b which will be described later thereto, respectively.

The partition unit 200b includes an elastic drying net 210b of a mesh material, and guide grooves 220b fastened to an outside of the drying net 210b and slidably mounted to the lifters 127b in a state a shape of the drying net 210b is maintained respectively.

It is preferable that the drying net 210b of an elastic material is formed to maintain a stretched state with a tension toward the rotation axis of the drum 120b when the partition unit 200b is mounted to the drum 120b.

It is preferable that the drying net 210b is of a bellows type which can be extended in a length direction of the drum 120b such that the drying net 210b has a maximum length and space when the drying net 210b is extended, and has a minimum length and space when the drying net 210b is contracted.

Placed in an outside circumference and an inside circumference of the bellows of the drying net 210b, there are guide frames 220b for maintaining a shape of the drying net 210b. For this, there are guide frame fastening pieces 212b formed at outside and inside of the bellows of the drying net 210b for fastening the guide frames 220b thereto.

The guide frame fastening pieces 212b may be seamed with the drying net 210b or fastened with an additional adhesive band. In the meantime, a number of the guide frame 220b to be fastened to the guide frame fastening pieces 212b may vary.

The guide frames 220b to be fastened to an outside circumference of the bellows which forms the drying net 210b are frames which form a hollow. The guide frame 220b has an extension 222b extended from an outside of the guide frame 220b toward the lifter 127b. The extension 222b at an end has a securing end 224b to be slidably placed in the slide groove 128b in each of the lifters 127b.

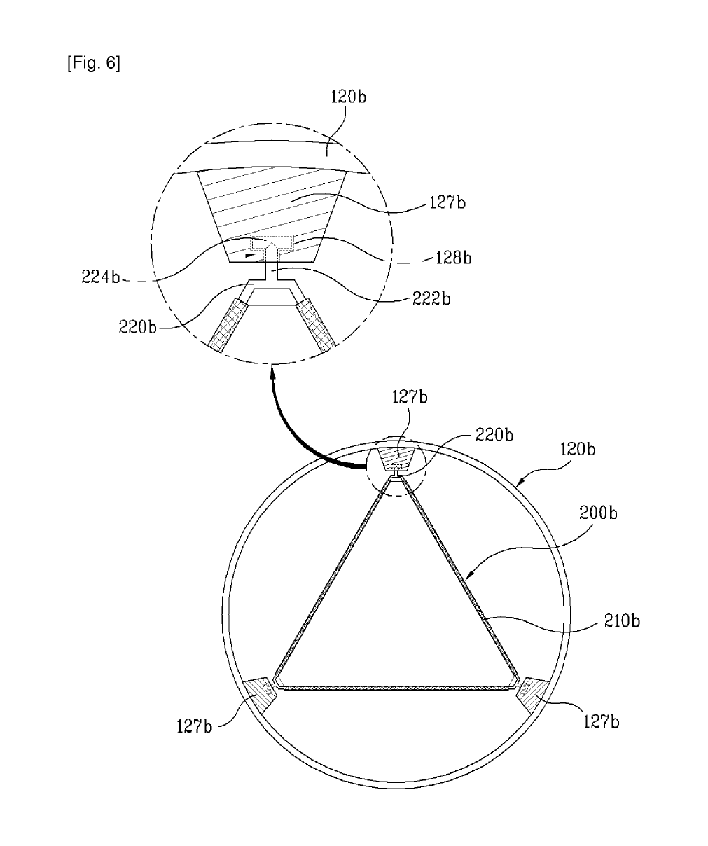

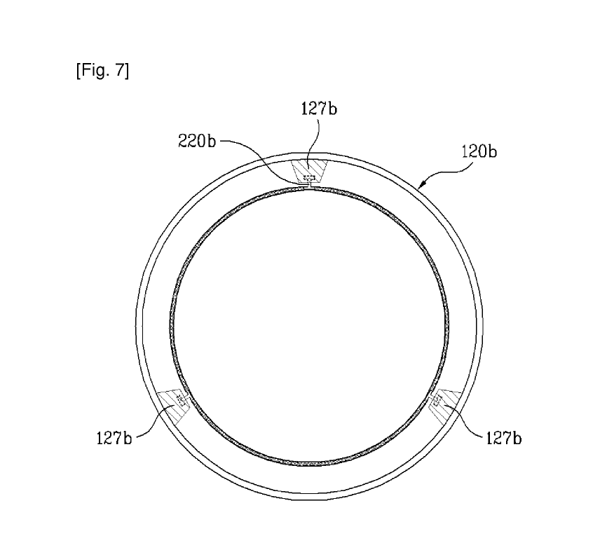

The guide frame 220b has a shape varying with a number of the lifters 127b mounted to the drum 120b. For an example, if a number of the lifters 127b mounted to the drum 120b are three, the guide frame 220b may have a triangular shape having sides each connecting the lifters 127b (See FIG. 6). Or, each of the sides connecting the three lifters mounted to the drum 120b may have an arc shape (i.e., an arc having a diameter smaller than an inside diameter of the drum 120b). (See FIG. 7)

According to the drum 120b and the partition unit 200b in accordance with a preferred embodiment of the present invention, when it is intended to dry a small amount of drying objects, by slidably moving the guide frames 220b of the partition unit 200b mounted to the lifters 127b of the drum 120b along the slide grooves 128b respectively, a space of the drying net 210b of the partition unit 200b can be expanded.

According to this, the inside of the drum 120a is partitioned into an inside and an outside of the partition unit 200b, enabling the small amount of drying objects to be placed in an inside space of the drying net 210a of the partition unit 200a or in a space formed between the drum 120b and an outside of the drying net 210b for drying.

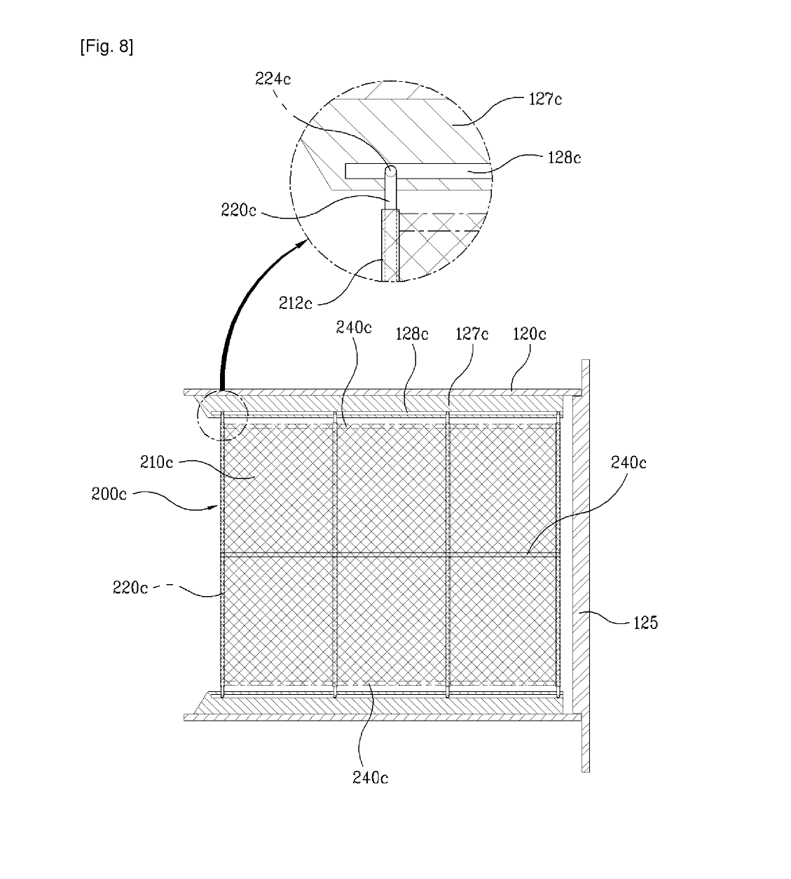

A drum and a partition unit in accordance with another preferred embodiment of the present invention will be described with reference to FIG. 8.

As shown, the drum 120c has a plurality of lifters 127c fixedly secured to an inside circumference of the drum 120c. The partition unit 200c is detachably and slidably mounted to edges of the lifters 127c.

Each of the lifters 127c has a T shaped slide groove 128c extended in a length direction of the lifter 127c at an edge of the lifter 127c on a rotation axis side of the drum 120c. Though not shown, the slide groove 128c has one pair of fastening holes at opposite ends for fastening front/rear guide frames 220c which will be described later thereto, respectively.

The partition unit 200c includes an elastic drying net 210c of a mesh material, a plurality of guide grooves 220c fastened to an outside of the drying net 210c and slidably mounted to the lifters 127c in a state a shape of the drying net 210c is maintained respectively, and movable frames 240c of a shape memory metal connecting a plurality of the guide frames 220c for extending/contracting according to an environmental temperature to vary a distance of the guide frames 220c.

It is preferable that the drying net 210c of an elastic material is formed to maintain a stretched state with a tension toward the rotation axis of the drum 120c when the partition unit 200c is mounted to the drum 120c.

It is preferable that the drying net 210c is of a bellows type which can be extended in a length direction of the drum 120c such that the drying net 210c has a maximum length and space when the drying net 210c is extended, and has a minimum length and space when the drying net 210c is contracted.

Placed in an outside circumference and an inside circumference of the bellows of the drying net 210c, there are guide frames 220c for maintaining a shape of the drying net 210c. For this, there are guide frame fastening pieces 212c formed at outside and inside of the bellows of the drying net 210c for fastening the guide frames 220c thereto. The guide frame fastening pieces 212c may be seamed with the drying net 210c or fastened with an additional adhesive band.

The guide frames 220c to be fastened to an outside circumference of the bellows which forms the drying net 210c are frames which form a hollow. The guide frame 220c has an extension 22c extended from an outside of the guide frame 220c toward the lifter 127c. The extension 222c at an end has a securing end 224c to be slidably placed in the slide groove 128c in each of the lifters 127c.

The movable frame 240c is secured to the drying net 210c in a length direction of the drying net 210c in conformity with a shape of the drying net 240c. At the same time with this, the movable frames 240c are connected to the guide frames 240c fastened to the drying net. It is preferable that the movable frames 240c are connected to the guide frames 240c matched to a number of the lifters 127c adjacent to the lifters 127c.

In the meantime, the movable frame 240c is formed of a shape memory metal which maintains the drying net 210c to be in a contracted state at a room temperature and deforms the drying net 210c in a direction of extension at a specific temperature (between the room temperature and a dry starting temperature). The movable frame 240c has a zigzag shape in conformity with a length direction shape of the drying net 210c, and is fastened to the guide frame 220c.

In the meantime, according to the drum 120c and the partition unit 200c in accordance with another preferred embodiment of the present invention described above, when it is intended to dry a small amount of drying objects, the clothe dryer 100 is controlled to heat the inside temperature of the drum 120c to a deformation temperature (between the room temperature and the drying temperature) of the movable frame 240c of the shape memory metal.

Then, following deformation of the shape of the movable frame 240c, the guide frames 220c fastened to the movable frames 240c move along the slide grooves 128c in the lifters 127c, to expand the space of the drying net 210c.

Eventually, as the inside of the drum 120c is partitioned into an inside and an outside of the partition unit 200c, enabling to place a small amount of drying objects in an inside space of the drying net 210c of the partition unit 200c or a space formed between the drum 120c and the drying net 210c for drying.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

For an example, other elements having additional functions or steps may be added to or replaced with the dryer 100 of the present invention. However, if other embodiments varied thus include essential elements of the present invention, it is required that the embodiments are within a scope of the present invention.

1. A dryer comprising:
a cabinet
a drum rotatably provided in the cabinet and having a plurality of lifters; and
a partition unit slidably movable along the lifters in a direction of a rotation axis of the drum for partitioning a drying space of the drum.

2. The dryer as claimed in claim 1, wherein the partition unit has a bellows type which is extendable/contractible in the direction of the rotation axis of the drum.

3. The dryer as claimed in claim 1, wherein the partition unit partitions a drying space of the drum into a center space and an outer space.

4. The dryer as claimed in claim 1, wherein the lifter includes a slide groove formed in a length direction of the lifter, and the partition unit is formed to extend/contract along the slide groove.

5. The dryer as claimed in claim 4, wherein the partition unit includes;
a drying net of a elastic mesh material which is to form a cylinder, and
a plurality of guide frames connected with each other along an outside circumference of the drying net to maintain a shape of the drying net and to be placed in the slide grooves.

6. The dryer as claimed in claim 5, wherein the guide frame includes a plurality of sides each connecting the plurality of lifters.

7. The dryer as claimed in claim 6, wherein the side includes an arc shape having a rotation axis the same with the drum.

8. The dryer as claimed in claim 6, wherein the guide frame includes a securing end to be placed in the slide groove at a corner of each of the sides.

9. The dryer as claimed in claim 5, further comprising moving unit for moving the guide frame along the slide groove.

10. The dryer as claimed in claim 9, wherein the moving unit comprises a movable frame of a shape memory metal arranged in zigzag along the lifter connected to the guide frame.

11. The dryer as claimed in claim 4, wherein the partition unit includes;
a drying net of an elastic mesh material which is to form a cylinder, and
a plurality of hooks provided at an outside circumference of the drying net to be placed in the slide grooves for supporting the drying net.

12. The dryer as claimed in claim 4, wherein the drying net includes an elastic fastening band provided at an outside circumference of the drying net for fastening the hook thereto, and
wherein the hook has one end with a holding ring for holding the fastening band and the other end with a securing end to be placed in the slide groove.
